(19) United States
(12) Patent Application Publication
(10) Pub. No.: US 2006/0105937 A1
(43) Pub. Date: May 18, 2006

(54) Aqueous cleaning composition

(75) Inventors: Melani Hardt Duran, Mesa, AZ (US); Ronnie Dale Casey, New River, AZ (US); John O. Hudson, Scottsdale, AZ (US)

Correspondence Address: THE DIAL CORPORATION;Suite 2214, 15501 North Dial Boulevard, Scottsdale, AZ, 85260-1619, US

(73) Assignees: Melani Hardt Duran; Ronnie Dale Casey; John O. Hudson

(21) Appl. No.: 10/989,162

(22) Filed: Nov. 15, 2004

(51) Int. Cl. C11D 3/00

(52) U.S. Cl. 510/504

(57) ABSTRACT

An aqueous cleaning composition is described having a nonionic component present in the amount of from about 0.01 to about 5% by weight of the composition, an optional cationic surfactant in the amount of from 0 to about 3% by weight of the composition, and a buffering agent present in the amount of from about 0.01 to about 5% by weight of the composition. The composition may be substantially free of organic solvents and preservatives. Due to the low base odor, a fragrance is optional.

### FIELD OF INVENTION

The present invention relates generally to an aqueous multi-surface cleaning solution. More particularly, the present invention relates to a spray cleaner that is an effective hard surface cleaner, and may also be used for fiber stain removal applications.

### BACKGROUND OF THE INVENTION

There are a number of liquid cleaners on the market today. In many cases, the cleaner can also be used for fiber stain removal, such as carpet spot cleaning or laundry pretreating. In general, many of these commercial solutions contain preservatives, and require organic solvents for oily soil removal. Many preservatives and organic solvents have distinctive aromas that either must be masked or that are used as signature scents for the product. Cleaning products containing signature scents are difficult to improve because there are limited options to modify the components and consumers associate properties of the product, such as the cleaning performance, with the origin components.

What is needed is an effective cleaning composition with a low base odor, which facilitates the development of consumer preferred aromas.

### SUMMARY OF THE INVENTION

The present invention provides a cleaning solution which may contain a nonionic surfactant, cationic surfactant, a chelant, sources of alkalinity, buffering agent, emulsifying agent, optional ingredients, and is substantially free of preservatives and organic solvent components. The present invention is an effective cleaner for fiber stain removal applications, as well as hard surface cleaning.

An exemplary embodiment of the present invention comprises an aqueous cleaning solution that includes a nonionic surfactant present in the amount of from about 0.01 to about 3% by weight of the composition, with optionally a cationic surfactant from about 0 to about 3%, a chelating agent present in the amount of from about 0.01 to about 1% by weight of the composition, and a buffering agent present in the amount of from about 0.01 to about 2% by weight of the composition, an emulsifying agent present in the amount of from about 0.01 to about 1% by weight and the composition is substantially free of preservatives and organic solvents.

### DETAILED DESCRIPTION

The following description is of an exemplary embodiment of the invention only, and is not intended to limit the scope, applicability, or configuration of the invention in any way. Rather, the following description is intended to provide a convenient illustration for implementing various aspects of the exemplary embodiment of the invention. As will become apparent, changes may be made in the function and arrangement of the elements described in this embodiment without departing from the spirit and scope of the invention.

That being said, generally, in accordance with the present invention, the liquid cleaning composition that is applied to the absorbent substrate is preferably a clear, isotropic solution having a viscosity generally less than 100 centipoise. For example, in accordance with various aspects of the present invention, the cleaning composition is water based and includes a nonionic surfactant, an optional cationic surfactant, a chelating agent, a buffering agent, sources of alkalinity, optional ingredients, and is free of preservatives and organic solvents. Water is the principal inert ingredient.

The nonionic surfactant component is present in the amount of from about 0.01% to about 3% by weight of the composition. More preferably, the nonionic surfactant component is present in the amount from about 0.05% to about 2% by weight of the composition, and most preferably is present in the amount of from about 0.1% to about 1% by weight of the composition.

In one aspect of the exemplary embodiment of the present invention, the nonionic surfactant component comprises ethoxylated alcohols. More preferably, the nonionic surfactant comprises C9-C10 ethoxylated alcohols. Optimally, a narrow range ethoxylate, is used providing fast penetration of fatty soils and improved performance on hard surfaces. Suitable nonionic surfactants include, in particular, the reaction products of compounds having a hydrophobic group and a reactive hydrogen atom, for example aliphatic alcohols, acids, amides or alkyl phenols with alkylene oxides, especially ethylene oxide either alone or with propylene oxide.

The nonionic material may also comprise an alkyl poly saccharide surfactant having the formula RO(CₙH₂ₙO)ₓZ_{y} or RCOO(CₙH₂ₙO)ₓZ_{y} wherein Z is a moiety derived from a reducing saccharide containing from 5 to 6 carbon atoms, preferably a glucose, galactose, glucosyl or galactosyl residue or mixtures thereof; R is a hydrophobic group selected from the group consisting of alkyl, alkenyl, alkyl phenol, hydroxy alkyl phenyl or hydroxy alkyl groups or mixtures thereof in which the alky groups contain from about 8 to about 20 carbon atoms.

A preferred nonionic surfactant is the Dehypound HSC series from Cognis which is a blend of the alkyl polysaccharide surfactant described above and a Dehypound ST series nonionic surfactant, which includes a defoaming compound, also from Cognis, as described in U.S. Pat. No. 5,827,453 owned by Henkel and incorporated by reference. More preferably, the surfactant is Dehypound HSC 5515 from Cognis.

Another embodiment of the invention contains a cationic surfactant, preferably a quaternary ammonium compound. The quaternary ammonium compounds are selected from mono-long-chain, tri-short-chain, tetraalkyl ammonium compounds, di-long-chain, di-short-chain tetraalkyl ammonium compounds, trialkyl, mono-benzyl ammonium compounds, and mixtures thereof. By “long” chain is meant about C₆₋₃₀ alkyl. By “short” chain is meant C₁₋₅ alkyl, preferably C₁₋₃. Most preferably, an ethoxylated quaternary coco alkylamine is used in the range of 0 to about 3% of the total composition, preferably about 0.1% to about 2%, most preferably about 0.3% to about 1.0%.

A preferred cationic surfactant is a quaternary ammonium compound known as the Berol series from Akzo Nobel and is described in U.S. Pat. No. 6,605,584 B2, herein incorporated by reference. Most preferred is a blend of a hydrophilic cationic surfactant and an ethoxylated alcohol supplied as Berol 226 from Akzo Nobel Surface Chemistry LLC, Chicago, Ill. and further described in U.S. Pat. No. 6,605,584 B2 and WO 02/081610 A1, herein incorporated by reference.

In the preferred embodiment of the present invention, a chelating agent is present in the amount of from about 0.01% to about 2% by weight of the composition. More preferably, the chelating agent is present in the amount of from about 0.05% to about 1% by weight of the composition, and, optimally, the chelating agent is present from about 0.1% to about 0.5% by weight of the composition.

In the exemplary embodiment of the present invention, the chelating agent can be selected from the group consisting of water soluble amino carboxylates, amino phosphates, poly-functionally substituted aromatic chelating agents and mixtures thereof, all as hereinafter defined. In yet another preferred embodiment of the present invention, the chelating agent is selected from the following amino carboxylates: ethylenediaminetetraacetic acid (EDTA), N-hydroxyethylenediaminetriacetates, nitrilotriacetates (NTA), ethylenediamine tetraproprionates, ethylenediamine-N,N′-diglutameates, 2-hydroxypropylenediamine-N,N′-disuccinates, trieethylenetetraaminehexacetates, diethylenetriaminepentaacetates (DTPA), and ethanoldiglycenes, including their water-soluble salts such as the alkali metal, ammonium, and substituted ammonium salts thereof, and mixtures thereof. Optimally the chelating agent comprises EDTA powder. It should be noted, however, that any suitable chelating agent now known or hereinafter known in the art may be used.

In the preferred embodiment of the present invention, a buffering agent is present in the amount of about 0.01 to about 2% by weight of the composition. It is yet more preferred that the buffering agent is present in the amount of from about 0.05% to about 1% by weight of the composition, and, optimally, the buffering agent is present in an amount of about 0.1 to about 0.5% by weight of the composition. In the exemplary embodiment of the present invention, the buffering agent is selected from borates, carbonates, citrates, amines. Optimally, the buffering agent comprises sodium tetraborate decahydrate.

A preferred buffering agent is commercially available as borax from the U.S. Borax Co. of California. Borax, preferably sodium tetraborate decahydrate, has the ability to buffer the cleaning solution to an effective pH range which promotes soil removal on fibers and on hard surfaces. In addition to its buffering capability, it functions as a deodorizer of body soils. The preferred embodiment of the invention contains MEA and sodium hydroxide as sources of alkalinity. It should be noted however that there are many such sources of alkalinity known in the art, such as other alkali metal salts of hydroxides, other alcohol amines, alkali metal carbonates, and phosphates.

In addition, in the liquid compositions of the invention, particularly those compositions used for all purpose cleaning, the omission of a preservative or preservative system provides compositions that may be formulated in more basic pH ranges such as in the range of about 8 to about 13, more preferably in the range of about 9 to about 12.5 and most preferably in the range of about 10 to about 12.2. Such basic formulations improve cleaning performance and are particularly effective against oily soils. The odor associated with most preservatives is also eliminated and the product may be formulated to enhance a customer's expectations of cleaning and cleanliness.

In the exemplary composition of the invention, an organic solvent is preferably eliminated from the compositions. Organic solvents generally are odiferous and must be either masked or used as a signal to customers of a product's heritage. The presence of a buffering component, preferably a borate, in a basic cleaning composition eliminates the requirement of a organic solvent and thus provides a base composition that is more neutral in odor.

In the preferred embodiment of the present invention a fragrance is present in the range of 0 to about 2% of the total composition, preferably about 0.1% to about 1%, most preferably about 0.15% to about 0.5%. In the presence of a fragrance, an effective emulsifier must be used to achieve an isotropic solution. A fragrance emulsifying agent is present in the range of 0 to about 3% of the total composition, preferably about 0.1% to about 2%, most preferably about 0.2% to about 1.0%.

In the exemplary embodiments of the present invention the fragrance emulsifier comprises alkyl (C₈-C₁₈) branched alcohols with ethylene oxide, and polyoxyalkylene block copolymer surfactants. Other fragrance emulsifying agents may include long chain tertiary amine oxides, long chain tertiary phosphine oxides and dialkyl sulfoxides.

Optional ingredients that the exemplary embodiment of the present invention may comprise, but are not limited to, include, one or more common additives, such as, dyes and pigments (preferably those that do not substantially deposit on hard surfaces). These optional ingredients may be limited in their application to a particular product form.

A possible mechanism as to the strength of the preferred embodiment of the invention is that the borax in the liquid cleaning solution reacts with hydroxyl groups of propylene glycol of the formulation. Therefore, bonding with other components of the cleaning solution is prevented and these components remain free to interact with soils for more effective cleaning.

The following is a non-limiting example of an exemplary embodiment of the present invention:

| Component | Weight % |
|---|---|
| Sodium Hydroxide | 0.1 |
| Dehypound^{®}HSC 5515⁽¹⁾ | 1.5 |
| Sodium Tetraborate Decahydrate | 0.25 |
| 2-aminoethanol | 0.5 |
| Surfonic TDA 15/88⁽²⁾ | 0.3 |
| Tetrasodium EDTA, 40% liquid | 0.4 |
| Fragrance | 0.15 |
| Propylene Glycol | 1.0 |
| Deionized Water | qs |

⁽¹⁾A blend of C₈₋₁₀ Alkyl Polyglucoside, C₁₂₋₁₄ Alkyl Polyglucoside, and a proprietary nonionic surfactant from Cognis.
⁽²⁾A branched tridecyl alcohol ethoxylate from Huntsman.

The following is another non-limiting example of an exemplary embodiment of the present invention:

| Component | Weight % |
|---|---|
| Sodium Hydroxide | 0.1 |
| Berol 226 SA ®⁽¹⁾ | 0.5 |
| Sodium Tetraborate Decahydrate | 0.25 |
| 2-aminoethanol | 0.25 |
| Genapol EP 1022⁽²⁾ | 0.36 |
| Tetrasodium EDTA Powder | 0.4 |
| Fragrance | 0.12 |
| Deionized Water | qs |

⁽¹⁾Proprietary blend of a quaternary ammonium compound and an ethoxylated alcohol, from Akzo Nobel.
⁽²⁾A methyl oxirane, polymer with oxirane, 8-methyl nonyl ether from Clariant.

Although, the following process description is written for batchwise compounding, it may be readily modified for continuous processing. Any of several common liquid blending mix tanks can be used to make the liquid intermediate bulk product. If the product contains fragrance, a premix may be needed to solubilize it. Such premix would include a surfactant which functions as an emulsifier. In the absence of fragrance, the following order of addition is preferred: water, the surfactant, tetrasodium EDTA, sodium tetraborate decahydrate, monoethanolamine, then sodium hydroxide.

It should be understood that the foregoing description of the present invention is of the preferred embodiment of the present invention, and the description is not intended to limit the scope of the invention. The examples of the preferred embodiment are for illustrative purposes only, and the present invention is not limited to the specific examples and compositions set forth herein. Various modifications may be made in light thereof as will be suggested to persons skilled in the art without departing from the scope of the invention as expressed in the claims.

What is claimed is:

1. An aqueous cleaning composition comprising:
a nonionic component present in the amount of from about 0.01 to about 5% by weight of the composition,
a cationic surfactant present in the amount of from 0 to about 3% by weight of the composition;
a buffering agent present in the amount of from about 0.01 to about 5% by weight of the composition;
a fragrance present in the amount of from 0 to about 2% by weight of the composition; and
a fragrance emulsifier present in the amount of from 0 to about 3%.

2. The cleaning composition of claim 1, wherein the composition is substantially free of an organic solvent.

3. The cleaning composition of claim 1, wherein the nonionic surfactant of the cleaning composition comprises C9-11 ethoxylated alcohols.

4. The cleaning composition of claim 1, wherein the cationic surfactant of the composition comprises a quaternary ammonium compound.

5. The cleaning composition of claim 1, wherein the cationic surfactant is Berol 226.

6. The cleaning composition of claim 1, wherein the nonionic surfactant comprises an alkyl poly saccharide surfactant having a chain length of about 8 to about 20 carbons.

7. The cleaning composition of claim 6 wherein the nonionic surfactant is Dehypound HSC 5515.

8. The cleaning composition of claim 1 wherein the buffering agent of the cleaning composition comprises sodium borate.

9. The cleaning composition of claim 1, wherein the cleaning composition is substantially free of a chemical preservative.

10. The cleaning composition of claim 1 further comprises optional additives selected from the group consisting of thickeners, dyes, pigments, and foam stabilizers.

11. The cleaning composition of claim 1, wherein the composition comprises a pH range of from about 8 to about 13.

12. The cleaning composition of claim 11, wherein the pH range is from about 10 to about 12.2.

13. An aqueous cleaning composition comprising:
a nonionic component present in the amount of from about 0.01 to about 5% by weight of the composition,
a cationic surfactant present in the amount of from 0 to about 3% by weight of the composition;
a buffering agent present in the amount of from about 0.01 to about 5% by weight of the composition;
a fragrance present in the amount of from 0.1% to about 1%; and
a fragrance emulsifier present in the amount of from 0.1% to about 2%.

14. The cleaning composition of claim 13, wherein the composition is substantially free of an organic solvent.

15. The cleaning composition of claim 13, wherein the nonionic surfactant of the cleaning composition comprises C9-11 ethoxylated alcohols.

16. The cleaning composition of claim 13, wherein the cationic surfactant of the composition comprises a quaternary ammonium compound.

17. The cleaning composition of claim 13 wherein the buffering agent of the cleaning composition comprises sodium borate.

18. The cleaning composition of claim 13, wherein the cleaning composition is substantially free of a chemical preservative.

19. An aqueous cleaning composition comprising:
a nonionic component present in the amount of from about 0.01 to about 5% by weight of the composition,
a cationic surfactant present in the amount of from 0 to about 3% by weight of the composition;
a buffering agent present in the amount of from about 0.01 to about 5% by weight of the composition;
a fragrance present in the amount of from 0.1% to about 1%;
a fragrance emulsifier present in the amount of from 0.1% to about 2%, wherein the composition is an isotropic solution.

20. The composition according to claim 19 wherein the composition is prepared by adding the surfactant before the buffering agent.
